(19) United States
(12) Patent Application Publication
(10) Pub. No.: US 2011/0282010 A1
(43) Pub. Date: Nov. 17, 2011

(54) EPOXY RESIN COMPOSITION

(75) Inventor: Jun Fujita, Tokyo (JP)

(73) Assignee: 3M INNOVATIVE PROPERTIES COMPANY, Saint Paul, MN (US)

(21) Appl. No.: 13/144,368

(22) PCT Filed: Jan. 13, 2010
(86) PCT No.: PCT/US2010/020864

§ 371 Date: Jul. 13, 2011

(30) Foreign Application Priority Data
Jan. 16, 2009 (JP) 2009-008198

(51) Int. Cl. C08L 63/00; C08L 63/02; C08L 71/10

(52) U.S. Cl. 525/396; 525/390

(57) ABSTRACT

An epoxy resin composition having low moisture permeability, transparency and a high refractive index. The epoxy resin composition includes an epoxy compound, and a compound having two or more crosslinking groups that are reactive with the epoxy compound. The weight ratio of (a) to (b) is from 0.3 to 3, and the epoxy resin composition has a refractive index of 1.6 or higher.

### FIELD OF INVENTION

The present invention relates to an epoxy resin composition with low moisture permeability.

### BACKGROUND

In general, an electronic device is susceptible to moisture as seen in short-circuit or electrode corrosion due to moisture condensation or in dimensional change or deterioration of a material due to moisture absorption. Accordingly, for allowing the device to operate over a long time, the device is often sealed by using a low moisture-permeable material.

For example, also in the case of bringing about no outside leakage of a liquid component such as electrolytic solution or liquid crystal of a lithium ion battery or a liquid crystal device, a low moisture-permeable resin material is used not only for preventing mere leakage but also reducing the effect of moisture passed and intruded through the material.

Above all, an organic EL device is extremely susceptible to moisture as compared with other electronic components and therefore, imposes very high requirement for moisture resistance in sealing. However, a sealing adhesive of conventional techniques is insufficient in terms of moisture permeability and in addition, the cured product of the sealing adhesive is colored in many cases. Accordingly, in the case of a light-emitting device of the type that extracts light through a sealing adhesive, such as organic EL device with a top emission structure (a structure of extracting light from the top side opposite the bottom side having thereon an electronic circuit), light of desired color cannot be emitted and sufficient light intensity is sometimes not obtained.

As to the method for encapsulating an organic EL device, various materials and structures have been proposed. For example, as for the sealing adhesive, an epoxy resin is used in many cases.

Patent Document 1 describes a method for sealing the peripheral part of an EL device by using a photocurable resin having two or more epoxy groups within the molecule.

In Patent Document 2, as regards a sealing adhesive usable also for an organic EL with a top emission structure, use of a bifunctional oxetane resin having a biphenyl structure is proposed.

Patent Document 3 describes a thermosetting film-like sealing composition containing an epoxy resin, a phenoxy resin and a latent imidazole.
Patent Document 1: Japanese Unexamined Patent Publication (Kokai) No. 2001-85155
Patent Document 2: Japanese Unexamined Patent Publication (Kokai) No. 2005-350546
Patent Document 3: Japanese Unexamined Patent Publication (Kokai) No. 2007-112956

### DISCLOSURE OF THE INVENTION

As described above, a low moisture-permeable transparent resin composition is demanded as a sealing resin composition for an electronic device, particularly an organic EL device. Also, the electrode or passivation film used in a top emission-type organic EL device generally has a high refractive index (in general, 1.6 or more). It is desired to enhance a light extraction efficiency by minimizing the difference in refractive index of the passivation film and the sealing resin to reduce reflection at the interface between them, and accordingly reduce an electric power consumption and enhance brightness of the organic EL device and extend its durable life. Therefore, it is desired to have a resin composition having a refractive index as near to the refractive index of the electrode and the passivation film as possible.

Accordingly, one object of the present invention is to provide an epoxy resin composition having low moisture permeability. Another object of the present invention is to provide an epoxy resin optical composition having transparency and a high refractive index. This optical composition is useful as a sealing resin composition for an organic EL device and by virtue of the above-described optical properties, is useful also as an optical composition for filling between a display unit and a protective plate in a display device such as liquid crystal display device.

### MEANS TO SOLVE THE PROBLEMS

The present invention includes the following embodiments.

1. An epoxy resin composition comprising:

(a) an epoxy compound, and

(b) a compound having two or more crosslinking groups that are reactive with the epoxy compound,

wherein the weight ratio of (a) to (b) is from 0.3 to 3, and the epoxy resin composition has a refractive index of 1.6 or higher.

2. The epoxy resin composition as described in (1), wherein the epoxy compound comprises a biphenyl structure.

3. The epoxy resin composition as described in (1) or (2), wherein the compound (b) having two or more crosslinking groups that are reactive with the epoxy compound is selected from the group consisting of a polyvalent epoxy compound, a polyvalent oxetane compound and a polyol.

4. An epoxy resin composition comprises

(a) an epoxy compound having a biphenyl structure, and

(b) a compound having two or more crosslinking groups that are reactive with the epoxy compound,

wherein the weight ratio of (a) to (b) is from 0.3 to 3.

5. The epoxy resin composition as described in (4), wherein the epoxy compound having a biphenyl structure is a monofunctional epoxy compound.

6. The epoxy resin composition as described in (4) or (5), wherein it further comprises a cationic curing catalyst.

7. The epoxy resin composition as described in any one of (4) to (6), wherein the compound (b) having two or more crosslinking groups that are reactive with the epoxy compound is selected from the group consisting of a polyvalent epoxy compound, a polyvalent oxetane compound and a polyol.

8. An electronic device using the epoxy resin composition formed from components (a) and (b) described in any one of (1) to (7).

Incidentally, “refractive index” is a value which is measured using Na D-ray (light having wavelength of 589.3 nm) at a temperature of 23° C.

### EFFECTS OF THE INVENTION

According to the above-described epoxy resin composition, low moisture permeability, high transparency and high refractive index are achieved.

### BEST MODE FOR CARRYING OUT THE INVENTION

Preferred embodiments of the present invention are described.

As described above, the epoxy resin composition of the present invention is an epoxy resin composition comprising (a) an epoxy compound, and (b) a compound having two or more crosslinking groups that are reactive with the epoxy compound, wherein the weight ratio of (a) to (b) is from 0.3 to 3, and the epoxy resin composition, for example, has a refractive index of 1.6 or higher.

In one embodiment, the epoxy resin composition contains a monofunctional epoxy compound having a biphenyl structure, as component (a). The monofunctional, biphenyl epoxy compound has one epoxy group and at least one biphenyl structure within one molecule. This structure, as compared to the conventionally used multi-functional biphenyl epoxy resin, imparts low moisture permeability, high refractive index and flexibility to the composition and contributes to reduction in the viscosity of the composition. The epoxy group (for example, glycidyl group) has high hydrophilicity and also has a relatively low refractive index. On the other hand, the biphenyl structure has high hydrophobicity due to two aromatic rings and has a high refractive index because of conjugation of two aromatic rings. In the epoxy compound (a), only one epoxy group is present in one molecule and in turn, the proportion of the biphenyl group becomes high, as a result, the compound comes to have low moisture permeability and a high refractive index. Also, this compound is monofunctional and therefore, when polymerized, the crosslinking density is not excessively raised and a soft cured product can be formed.

Furthermore, the epoxy compound (a) appropriately raises the crosslinking density through reaction with the compound (b) having two or more crosslinking groups that are reactive with the epoxy compound, whereby excellent heat resistance and flexibility of the cured product can be realized.

The monofunctional epoxy compound (a) is a compound having a biphenyl structure and only one epoxy group, and the epoxy group is derived, for example, from a glycidyl group. As long as the effects of the present invention are not impaired, the biphenyl structure may be substituted by a substituent. Examples of the substituent include an aliphatic, alicyclic or aromatic hydrocarbon group. For example, the aromatic group is considered to maintain low moisture permeability and high refractive index. Also, the epoxy group (for example, glycidyl group) and the biphenyl structure are bonded through a divalent organic bond group, for example, a divalent aliphatic, alicyclic or aromatic hydrocarbon group, or bonded directly.

The compound that is confirmed to be preferred as the monofunctional epoxy compound (a) is, for example, the following compound.

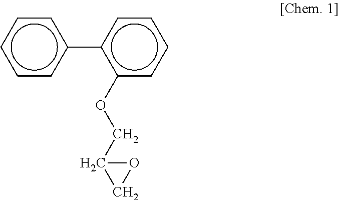

The epoxy compound (a) and the compound (b) having two or more crosslinking groups that are reactive with the epoxy compound are used in a weight ratio of (a)/(b) of 0.3 to 3. If the ratio of (a)/(b) is less than 0.3, the moisture impermeability of the obtained cured product deteriorates and also the refractive index sometimes becomes insufficient, whereas if the ratio of (a)/(b) exceeds 3, a sufficient crosslinking density is not obtained after curing and poor cohesive force results in some cases.

The compound (b) having two or more crosslinking groups that are reactive with the epoxy compound is not particularly limited as long as it has high compatibility with the compound (a) and can participate in crosslinking by reacting with the compound (a) when curing the composition. Specifically, the compound is an epoxy resin such as bisphenol A-type epoxy resin, bisphenol F-type epoxy resin, biphenyl-type epoxy resin, phenol novolak-type epoxy resin, cresol novolak-type epoxy resin and hydrogenated bisphenol A-type epoxy resin, an oxetane resin such as xylylene bis-oxetane, 2-ethyl-3 {[(3-ethyl oxetan-3-yl)metyhoxy]methyl} oxetane, 3-ethyl-3-hydroxymethyl oxetane (oxetane alcohol), 4,4′-bis[(3-ethyl oxetan-3-yl)methoxy]methylbiphenyl, a vinyl ether resin such as butane diol-1,4-divinyletherhexanediol-1,6-divinylether, cyclohexane dimethanol divinyl ether, tripropylene glycol divinyl ether or liquid polyols such as polyester polyol, polyether polyol or polycarbonate polyol. The polyols act as a chain transfer agent when cationically polymerizing the epoxy resin and becomes a part of the cured product. For example, a polyester, a polycarbonate, a polyamide or a phenoxy resin which is solid at a normal temperature also has a carboxyl group or a hydroxyl group at the polymer terminal and by using such a high molecular polymer, toughness of the cured product may be enhanced or the composition before curing may be shaped into a film form. Preferred resins are a bisphenol A-type epoxy resin and a bis-fluorene epoxy resin.

As described above, the epoxy resin composition, in one embodiment, comprises (a) a monofunctional epoxy compound having a biphenyl structure. When the compound (a) comprises a monofunctional biphenyl epoxy, the curing catalyst (c) may be used as a curing agent. Curing agents for epoxy include catalyst-type curing agents which initiate polymerization by ring-opening of epoxy groups (hereinafter, referred to as “curing catalyst”), and addition-type curing agents such as an amine compound or polyhydric phenols which cures the resin by addition reaction with epoxy group. When the composition includes a monofunctional biphenyl epoxy, a sufficient crosslinked structure may not be obtained if an addition-type curing agent is used.

Specifically, an optical or thermal cationic curing catalyst such as iodonium, sulfonium and phosphonium salts, or an anionic curing catalyst such as imidazoles and acid anhydride, may be used. In particular, a cationic curing catalyst is preferred, and an optical cationic curing catalyst is more preferred, because a polymerization reaction does not start unless light is applied and therefore, the storage stability is good. As for the specific cationic curing catalyst, a salt composed of a cation such as alkyl or aryl group-substituted iodonium, sulfonium or phosphonium and an anion such as SbF₆, BF₄, B(C₆F₅)₄, PF₆, P(Rf)ₙF₍₆₋ₙ₎, CₙF₂ₙ₊₁SO₃, N(SO₂CF₃)₂ or C(SO₂CF₃)₃, is used. Specific examples thereof include CI Series such as PI-2074 produced by Rhodia, CPI Series such as CPI200K and CPI210S produced by SAN-APRO Ltd., CI2920 produced by Nippon Soda Co., Ltd., Optomer SP Series such as Optomer SP-150 and Opton CP Series such as CP-66 produced by Adeka Corp., SANAID Series produced by Sanshin Chemical Industry Co., Ltd., and WPAG Series and WPI Series produced by Wako Pure Chemical Industries, Ltd. In particular, anion species B(C₆F₅)₄, P(perfluoroalkyl)ₙF₍₆₋ₙ₎, N(SO₂CF₃)₂ and C(SO₂CF₃)₃ are preferred in view of reactivity, and sulfonium cation is preferred in view of storage stability. The amount of the curing agent added is in the range of 0.01 to 20 weight % based on the total weight of the epoxy compound (a) and the compound (b) having two or more crosslinking groups that are reactive with the epoxy compound. If the amount added is less than 0.01 weight %, the curing rate is low, whereas if it exceeds 20 weight %, the cured product may be colored.

The composition of the present invention may be used, when it is liquid, by coating the liquid composition as it is, irradiating light thereon, and curing the coating under heating or after lamination to an adherend, curing the coating under heating. Also, the composition of the present invention is, when it is solid, formed into a liquid by dissolving the composition in an appropriate solvent such as methyl ethyl ketone (MEK), and the liquid composition is coated, dried, irradiated with light and then cured under heating or after lamination to an adherend, cured under heating to work as a sealing agent or the like.

Furthermore, the composition of the present invention may be previously formed into a film, and the film may be disposed on a surface intended to adhere and after laminating adherends to each other, cured by irradiation with light and/or under heating.

As long as the effects of the present invention are not impaired, the epoxy composition of the present invention may contain other components such as additive. Examples of the additive include, but are not limited to, a filler, a sensitizer and a coupling agent.

As for the filler, an inorganic filler such as silica, alumina, tin oxide, antimony oxide, zirconia, titania, boron nitride, aluminum nitride, silicon carbide and bentonite, and in the case where insulation is of no importance, a carbon-based filler such as carbon black, graphite and carbon nanotube, or a metal particle-based electrically conductive filler, may be used. The purpose of addition of the filler is to improve adhesiveness, to impart thixotropy of the liquid composition, and to adjust a refractive index, etc. The amount of addition of the filler is 0.1 to 75 weight %, based on the total weight of the composition. If it is 0.1 weight % or less, effect of addition can not be achieved. If it is 75 weight % or more, fluidity of the composition is low and the composition may lose adhesiveness.

The particle diameter of the filler is not particularly limited but in the case of using the composition in an application which requires transparency, a filler having a particle diameter of 1 to 100 nm is preferably used, because the transparency of the composition is scarcely impaired.

The refractive index of the filler is not particularly limited, and the filler having a refractive index of 1.3 to 2.8 can be used. When the composition is used for an application which requires transparency of the composition, a filler having a refractive index of 1.5 to 2.4 is preferred and to enhance a refractive index, a filler having a refractive index of 1.6 to 2.8 is preferred.

The filler can be subjected to surface treatment to improve its dispersity into the epoxy resin or to reduce water absorbency.

As for the sensitizer, those having a skeleton of anthracene, anthraquinone, thioxanthone or benzophenone are known, but the sensitizer is not particularly limited. Specifically, 2,9-butoxyanthraquinone (UVS-1331, produced by Kawasaki Kagaku Kogyo K.K.), Kayacure DETX-S (produced by Nippon Kayaku Co., Ltd.) and the like are commercially available.

As for the coupling agent, a silane coupling agent, a titanate-based coupling agent, an aluminate-based coupling agent and the like may be used. Specifically, there may be used a silane coupling agent such as vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxylsilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-mercaptopropylmethyldimethoxysilane, 3-mercaptopropyltrimethoxysilane, bis(triethoxysilylpropyl)tetrasulfide and 3-isocyanatopropyltriethoxysilane, and a titanate-based coupling agent such as PLENACT Series (produced by Ajinomoto Fine-Techno Co., Inc.) and TITABOND (produced by Nippon Soda Co., Ltd.). By using these coupling agents, adhesiveness of the epoxy resin composition to an adherend and dispersibility of the filler can be improved.

### BRIEF DESCRIPTION OF THE DRAWINGS

FIG. 1 is a cross-sectional view of an organic electroluminescent (EL) device using the composition of the present invention. In FIG. 1, the organic EL device 10 is a top emission type of emitting light toward above the device, where a circuit 2 is formed on a substrate 1 and a stack 3 that controls the light-emitting function is formed thereon. Although not illustrated, the stack 3 has an anode, a light-emitting unit and a cathode, and the light-emitting unit has a layer containing an organic EL light-emitting material. Furthermore, a passivation film 4 having a water vapor barrier property or an oxygen barrier property is formed on the stack 3. On such a structure, a sealing agent 5 comprising the composition of the present invention is formed, and protective layer 6 such as glass is provided thereon. The electrode or passivation film generally has a high refractive index, and the refractive index thereof is usually 1.6 or more. In order to raise the light extraction efficiency, the refractive index of the sealing agent is required to be near to the refractive index above. As a sealing agent for a top emission-type EL device, a sealing agent having a high light transmittance is desired. Therefore, when a filler is contained in the composition, it is preferably contained in an amount of 50% or less of the weight of the composition. Further, the filler preferably has a particle diameter of 1 nm to 100 nm, and particularly preferably 1 nm to 30 nm. In addition, the filler preferably has a refractive index of 1.5 to 2.4 in order not to remarkably reduce a refractive index and light transmittance of the composition.

Incidentally, measurement method of particle diameter is generally determined depending on particle sizes. For example, image analytical method for a wide variety of average particle diameters, dynamic light scattering method for average particle diameters of 100 nm or smaller (JISZ8826, 2001), and laser diffraction/scattering method for average particle diameters of 100 nm or larger (JISZ8825, 2001) may be used.

FIG. 2 illustrates a cross-sectional view of an ultraviolet light-emitting diode (LED) device to which the composition of the present invention is applied. In the ultraviolet light-emitting diode (LED) device 20 illustrated in FIG. 2, a stack 3 that controls light emission is formed on a substrate 1, and a protective layer 6 is formed thereon. The peripheral circumference of the device 20 is sealed by a sealing agent 5. In this usage, when high light transmittance is not required, a filler having a large particle diameter may be further added.

The composition of the present invention has a high refractive index and a high light transmittance and therefore, can be used also in optical applications other than the usage above. For example, the composition can be used as an optical material such as reflective sheet by using a microreplication technique. Also, the composition can be suitably used as a filling material for filling the gap between a display unit and a protective plate of a liquid crystal display. Furthermore, by virtue of low moisture permeability, the composition can be used as a sealing material for an electronic device, an electrolytic solution or the like.

### EXAMPLES

The present invention is described in greater detail below by referring to Examples. The present invention is not limited to these Examples.

### Example 1

### Preparation of Sealing Agent Composition

50 parts by weight of a monofunctional epoxy compound having a biphenyl structure (OPP-G, produced by Sanko Sha), 50 parts by weight of a bisphenol A-type epoxy resin (YD8125, produced by Tohto Kasei Co., Ltd.), 0.5 parts by weight of a cationic light curing catalyst (CPI-210S, produced by SAN-APRO L Ltd.) and 0.1 parts by weight of a sensitizer (4-hydroxybenzophenone, produced by Tohto Kasei Co., Ltd.) were mixed to obtain a composition having a viscosity of 3,300 mPas.

### Measurement of Moisture Permeability:

The sample for measurement was prepared as follows. First, the composition prepared as above was coated on a 38 μm-thick polyethylene terephthalate (PET) film subjected to a release treatment, and a polyethylene terephthalate (PET) film subjected to the same release treatment was disposed thereon. After irradiating an ultraviolet ray (F300S (using H bulb) manufactured by Fusion, 100 mJ, 20 times), the coating was cured in an oven at 80° C. for 60 minutes, whereby a 100 μm-thick transparent film was obtained.

Using the 100 μm-thick film prepared by the method above, the moisture permeability rate was measured by a cup method in accordance with JIS Z0208. In the measurement, the moisture permeability rate for 24 hours was measured using a constant-temperature constant-humidity bath at 60° C. and a relative humidity of 90%. The measurement was performed twice for one sample, and the average of moisture permeability rates in each measurement is shown in Table 2. In Example 1, a low moisture permeability of 17 g/m²/24 h was exhibited.

### Measurement of Visible Light Transmittance:

The measurement of the visible light transmittance was performed using a spectroscope U-4000. A 100 μm-thick film produced by the method above was used as the sample for measurement. The average transmittance in the wavelength region of 400 to 800 nm is shown in Table 2.

### Measurement of Refractive Index:

The refractive index was measured at room temperature (23° C.) at the Na-D ray by using an Abbe refractometer manufactured by ATAGO Co., Ltd. A sample for measurement was prepared by cutting the film as prepared using the above method into 10 mm×20 mm. α-bromonaphthalene (refractive index nD=1.657) was used as an intermediate liquid between the sample and the prism surface of the refractometer.

### Examples 2 to 5 and 7 to 9

Compositions were prepared in the same manner as in Example 1 except for changing the materials as shown in Table 1 and evaluated in the same manner.

### Example 6

The materials shown in Table 1 were dissolved in methyl ethyl ketone (MEK) to prepare a solution of 30 wt %, and the solution was coated on a 38 μm-thick release-treated PET film by using a knife coater to obtain a 100 μm-thick transparent film. Subsequently, the film was evaluated in the same manner as in Example 1.

TABLE 1

| | Epoxy | Resin | Resin | Resin | Resin | Resin | Cata- | Cata- | Dye Sensi- | Dye Sensi- | Coupling | | |
|---|---|---|---|---|---|---|---|---|---|---|---|---|---|
| | Resin 1 | 2 | 3 | 4 | 5 | 6 | lyst 1 | lyst 2 | tizer 1 | tizer 2 | Agent | Filler 1 | Filler 2 |
| Example 1 | 50 | 50 | | | | | 0.5 | | 0.1 | | 1 | | |
| 2 | 70 | 30 | | | | | | 0.5 | 0.1 | | | | |
| 3 | 70 | | 30 | | | | | 0.5 | 0.1 | | 1 | | |
| 4 | 70 | | | 30 | | | | 0.5 | 0.1 | | 1 | | |
| 5 | 40 | 30 | | | 30 | | | 0.5 | | | 1 | | |
| 6 | 50 | | | | | 50 | | 0.5 | | | 1 | | |
| 7 | 45 | 45 | | | | | | 0.5 | | 0.1 | 1 | 10 | |
| 8 | 30 | 70 | | | | | | 0.5 | | 0.1 | 1 | | 75 |
| 9 | 12.5 | 12.5 | | | | | | 0.5 | | 0.1 | 1 | | |
| Comparative | | 50 | | 50 | | | | 0.5 | | 0.1 | | | |
| Example 1 | | | | | | | | | | | | | |
| Comparative | | | | 100 | | | | 0.5 | | 0.1 | | | |
| Example 2 | | | | | | | | | | | | | |

Epoxy resin 1 (monofunctional epoxy compound having a biphenyl structure): o-Phenylphenol glycidyl ether (OPP-G, produced by Sanko Sha)
Resin 2 (compound having two or more crosslinking groups that are reactive with an epoxy group): Bisphenol A diglycidyl ether (YD8125, produced by Tohto Kasei Co., Ltd.)
Resin 3: Di(glycidyl-methyltricyclodecane) (EP4088S, produced by Adeka Corp.)
Resin 4: 4,4′-Bis[(3-ethyloxetan-3-yl)methoxy]methylbiphenyl (OXBP, produced by Ube Industries, Ltd.)
Resin 5: Bisphenolfluorene diglycidyl ether (EX1010, produced by Osaka Gas Chemicals Co., Ltd.)
Resin 6: Phenoxy resin (YP50, produced by Tohto Kasei Co., Ltd.)
Curing Catalyst 1: Aromatic Iodonium perfluoroalkyl fluorophosphate (cationic curing catalyst system CPI-210S, produced by SAN-APRO)
Curing Catalyst 2: Aromatic sulfonium perfluorophenyl borate (cationic curing catalyst, 2074, produced by Rhodia)
Dye sensitizer 1: 4-Hydroxybenzophenone (produced by Tohto Kasei Co., Ltd.)
Dye sensitizer 2: 2,9-Butoxyanthraquinone (UVS-1331, produced by Kawasaki Kagaku Kogyo K.K.)
Coupling agent 1: 3-Glycidoxypropyltrimethoxysilane (KBM403, produced by Shin-Etsu Chemical Co., Ltd.)
Filler 1: Fumed silica (R972, average particle diameter: 16 nm, produced by Nippon Aerosil Co., Ltd.) (measurement for average particle diameter was carried out by image analytical method by electron microscope as described above)
Filler 2: Fumed silica (FB-3SDC, average particle diameter: 3.4 μm, produced by Denki Kagaku Kogyo K.K.) (measurement for average particle diameter was carried out by laser diffraction/scattering method as described above)

TABLE 2

| | Moisture | Light | |
|---|---|---|---|
| | Permeability | Transmittance | |
| | (g/m² · 24 h) | (%) | Refractive Index |
| Example 1 | 17 | 92 | 1.61 |
| 2 | 36 | 92 | 1.60 |
| 3 | 36 | 92 | 1.60 |
| 4 | 36 | 90 | 1.61 |
| 5 | 30 | 92 | 1.62 |
| 6 | 37 | 93 | 1.61 |
| 7 | 17 | 89 | 1.61 |
| 8 | 40 | 91 | 1.61 |
| 9 | 7 | — | — |
| Comparative | 46 | 90 | 1.58 |
| Example 1 | | | |
| Comparative | 59 | 88 | 1.57 |
| Example 2 | | | |

The composition of the present invention satisfies both a low moisture permeability of 40 g/m²·24 h or less and a high refractive index of 1.6 or more and is suitable for sealing a top emission-type organic electroluminescent (EL) device. Also, as revealed in Example 9, very low moisture permeability can be realized by adding a filler and therefore, the composition can be used as a sealing agent for the peripheral part of an ultraviolet light-emitting diode (LED) using a sealing glass. Furthermore, the composition can be suitably used in the optical application requiring high refractive index and high light transmittance, for example, for filling the gap between a display unit and a protective plate of a liquid crystal display.

### BRIEF DESCRIPTION OF THE DRAWINGS

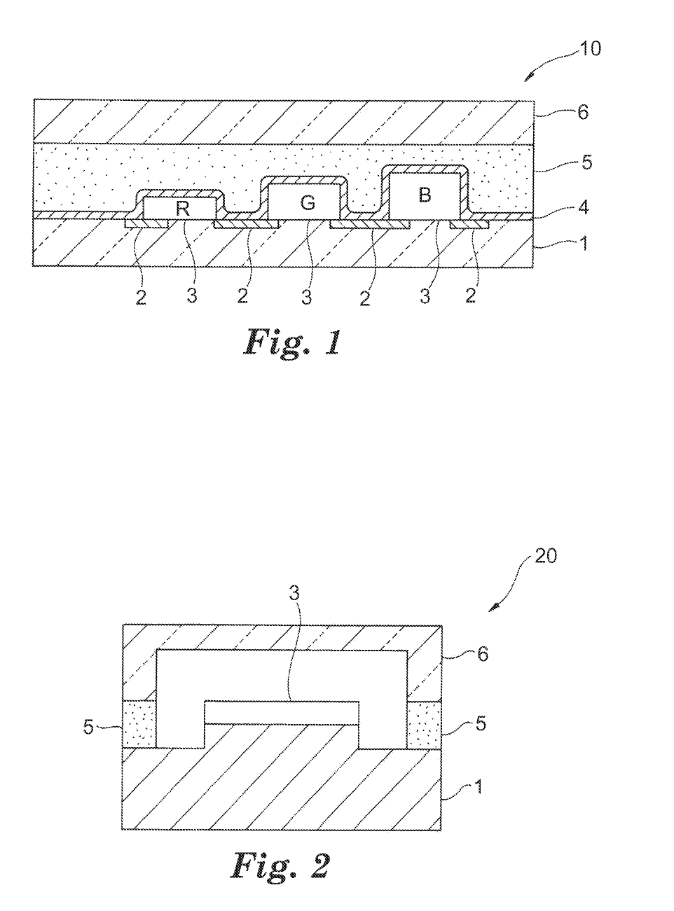

FIG. 1 A cross-sectional view of an organic electroluminescent (EL) device to which the composition of the present invention is applied.

FIG. 2 A cross-sectional view of an ultraviolet light-emitting diode (LED) device to which the composition of the present invention is applied.

### DESCRIPTION OF NUMERICAL REFERENCES

10 Organic EL device
20 Ultraviolet light-emitting diode (LED) device
1 Substrate
2 Circuit
3 Stack that controls the light-emitting function
4 Passivation film
5 Sealing agent
6 Protective layer

We claim:

1. An epoxy resin composition comprising:
(a) an epoxy compound, and
(b) a compound having two or more crosslinking groups that are reactive with the epoxy compound,
wherein the weight ratio of (a) to (b) is from 0.3 to 3, and the epoxy resin composition has a refractive index of 1.6 or higher.

2. The epoxy resin composition as claimed in claim 1, wherein the epoxy compound comprises a biphenyl structure.

3. The epoxy resin composition as claimed in claim 1, wherein the compound (b) having two or more crosslinking groups that are reactive with the epoxy compound is selected from the group consisting of a polyvalent epoxy compound, a polyvalent oxetane compound and a polyol.

4. An epoxy resin composition comprises
(a) an epoxy compound having a biphenyl structure, and
(b) a compound having two or more crosslinking groups that are reactive with the epoxy compound,
wherein the weight ratio of (a) to (b) is from 0.3 to 3.

5. The epoxy resin composition as claimed in claim 4, wherein the epoxy compound having a biphenyl structure is a monofunctional epoxy compound.

6. The epoxy resin composition as claimed in claim 4, wherein it further comprises a cationic curing catalyst.

7. The epoxy resin composition as claimed in claim 4, wherein the compound (b) having two or more crosslinking groups that are reactive with the epoxy compound is selected from the group consisting of a polyvalent epoxy compound, a polyvalent oxetane compound and a polyol.

8. An electronic device using the epoxy resin composition formed from components (a) and (b) claimed in 1.

9. An electronic device using the epoxy resin composition formed from components (a) and (b) claimed in 4.
